(19) United States
(12) Patent Application Publication
(10) Pub. No.: US 2015/0323432 A1
(43) Pub. Date: Nov. 12, 2015

(54) Pin loaded small one-bar specimen (OBS)

(71) Applicant: Balhassn S. M. Ali, Cheverly, MD (US)

(72) Inventor: Balhassn S. M. Ali, Cheverly, MD (US)

(21) Appl. No.: 14/274,620

(22) Filed: May 9, 2014

(51) Int. Cl. G01N 3/08

(52) U.S. Cl. CPC G01N 3/08

(57) ABSTRACT

This innovation comes as development to the small specimens creep testing methods which are used to determine the material mechanical properties, creep strength and to determine the remaining life time for the critical high temperature engineering components operating at creep range. The Pin loaded small one-bar specimen can be made from small material samples removed from the component suffuses or from small material zones such as the heat effected zone (HAZ) or from the weld metal (WM) of welded joints. The specimen is loaded using four loading pins connected to flexible loading joints, under high temperature and stress levels, until the rupture of the specimen. The specimen deformation is recorded throughout the test duration and then converted to the corresponding uniaxial date using conversion relationships. The converted test results than used to obtain the creep strength and to determine the remaining life time for the components. The conversion relationships and the conversion factors are obtained using the finite element analyses. Full creep strain time curves can be obtained using this specimen type, therefor the specimen is capable of obtaining the minimum creep strain and rupture data. The creep data obtained from the small OBS are compared with the corresponding, uniaxial, experimental results for P92 steel at 650° C. and for P91 steel at 650° C. The results show remarkably good agreement between the creep data obtained from the finite element analyses for the small OBS and the experimental uniaxial creep data. The advantages and the future work of the testing techniques are also highlighted.

### 1. THE USE OF THE SMALL SPECIMENS CREEP TESTING

Many of the high temperature components such as, components in the traditional and the nuclear power plants, chemical plants and oil refinery are operating at creep range. Many of these components are approaching the end of their design life. Therefore, creep strength of these components need to be carefully assessed on regular bases; in order to insure the safe operation of these critical engineering components. Typically a cylindrical a uniaxial specimen with length approximately 130 mm and diameter of about 10 mm see FIG. 1, is used to assess the creep strength. This specimen type is the standard creep test specimen and a full creep strain time curves can be obtained using this specimen type i.e. primary, secondary and tertiary creep regions, see FIG. 2. In addition, the results of this specimen are the reference to any other unconventional creep testing technique.

However, in many of the high temperature components creep assessment situations; it is not possible to manufacture the conventional uniaxial creep test specimen, due to the limitation of the material available for testing. As an example creep assessment for pressurized steam vessels, pipe bends and headers in the power plans, chemical plants or oil refineries. These components normally assessed by removing small material samples from their surface, the small samples dominations approximately 2-3 mm depth, 15-30 mm length and 15-30 mm width [2]. These small samples can be removed from differing locations on the components surfaces, without effecting the safe operation of these components. These small samples then can then be used to manufacture small specimens and then these specimens can be creep tested to give an indication of the creep strength and the remaining life time of these components.

### 2. THE LIMITATIONS OF THE TRADITIONAL, IN USE SMALL SPECIMEN CREEP TESTING METHODS

In the pest many attempts have been made in order to determine the creep strength and the remaining life time for the high temperature components such as the impression and the small ring creep test [1, 3, 4]. However, both testing techniques are limited to the secondary creep region; therefore theses testing techniques do not give any information about the tertiary region. The small punch creep test has been used as an attempt to obtain the full creep strain time curve. However, due to the complications associated with this testing method it has not been accepted and standardized worldwide. Some of these complications are related to (i) the large elastic and plastic deformation accord during the test which make it is very default to convert the small punch creep test result to the corresponding uniaxial creep test data, (ii) Increasing contact area between the specimen and the loading device during the test which make it very difficult to determine the corresponding uniaxial stress.

The sup size uniaxial specimen has been also used when the available material is limited, however this testing method is not accurate because of three reasons:—
A—Due to the small specimen size the specimen ends have to be welded to the specimen using different material for loading application. Weld means changing the mechanical properties in and around the welded regions especially in the soft heat affected zoon region, which mean the test result will not represent the component creep strength accurately
B—The second issue is the loading and alignment, welding small cylindrical bar from both ends with good alignment in place is not straightforward task, it requires sophisticated and expensive welding and creep testing machines
C—Machining and polishing small cylindrical specimen with good finishing is expensive and not an easy task.

### 3. BRIEF DESCRIPTION OF THE NATURE AND INTENDED USE OF THE OBS

The newly invented The Pin loaded small one-bar specimen (OBS) see FIG. 3 and FIG. 4 can be used to obtain material creep strength and to determine the renaming life time for the high temperature components accurately [5]. The OBS can be manufactured using small material samples removed from the components surface or form critical welded regions such as welded metal or the heat affected zones of weld. The OBS can successfully replace all previous small specimens' creep testing techniques, and also some of the other specimen which are used to assess creep strength for small material zones, such as the Cross-weld waisted specimen and the Cross-weld uniaxial specimen which are used to assess the creep strength for the HAZ region.

Unlike other small creep test specimens, the OBS can produce full creep strain time curves, i.e. the three creep regions, primary, secondary and tertiary, with very good accuracy when compared with the corresponding uniaxial creep test data [5]. The main advantages of the small OBS testing technique over the rest of the small specimens creep test techniques can be summarised in the following points:—

1—The OBS is unlike the impression creep test or the small ring creep test, the OBS can obtain a full creep strain-time curves identical to the corresponding uniaxial specimen creep strain-time curves.
2—Unlike the sup-size uniaxial specimen where the two ends need to be welded for loading application, the specimen does not have any weld at any stage of the specimen preparation. In addition the OBS has self-alignment properties as the specimen loaded through four loading pins and flexible loading joints.
3—Unlike the small punch creep test where the elastic and the plastic deformation is very large. In the case of the OBS the elastic and the plastic deformation during the test is negligible.
4—Unlike the small punch creep test where the specimen shape change significantly during the test; the OBS over all shape and dimensions does not change significantly during the test. Therefore, the small changes in the specimen dimensions have insignificant effect on the geometry dependent conversion factors β and η.
5—Compare to the sup-size uniaxial specimen the small OBS is easy to be manufactured and loaded of the welded joints
6—The entire OBS can be made using very limited volumes of material, therefore the OBS can be used to obtain the full creep strain time curves for the critical heat affected zones or weld metal.
7—Unlike the impression creep test where the indenter material has to be much higher creep resentence than the tested material, the OBS can be loaded using loading bins with similar creep resentence as the tested material.
8—The OBS testing method is capable of determine the remaining life time for the component prissily, which mean it can be used to increase the safe operation of traditional and the nuclear power and chemical plants.
9—The OBS allow engineers to accurately determine the current creep strength for the high temperature operating components. Therefore, the efficiency of the existing and new power plants can be increase by increasing the operating pressure and or temperature; which will lead to the reduction of the fuel consumption.
10—The OBS is non-destructive testing technique; therefore components can be assessed as they are operating, whiteout the need to shut down the plant.

### 4. SPECIMENS GEOMETRIES AND DIMENSIONS

The OBS has simple geometry and dimensions and it can be easily manufactured using electric discharge machine (EDM) or leaser cutting machine. The specimen dimensions are defined by Lₒ, b, d, h, R and k; where Lₒ is “bar” length, i.e. the distance between the centres of the loading pins, b is the bar width, d is the specimen thickness, H is the specimen height, R is the radius of the loading pins and k is the length of the loading pin supporting end, as shown in FIG. 3. In order to achieve good alignment during the loading application the specimen has been loaded using flexible loading fixture as in FIG. 4.

### 5. DATE CONVERSION METHOD

Traditionally, to determine stress level for the conventional uniaxial creep test specimen, the applied load is divided by the cross section area of the specimen, i.e.,

$${σ}_{nom} = \frac{P}{A} \qquad ( 1 )$$

where σ is the nominal stress, P is the applied load and A is the cross section area, i.e. A=πr², for the case of cylindrical uniaxial specimen. The creep strain ε^{c} for the conventional cylindrical uniaxial specimen case can be calculated by dividing the specimen extension by the original length, i.e.

$${ɛ}^{c} = \frac{{L}_{2} - {L}_{1}}{{L}_{1}} \qquad ( 2 )$$

and L₂−L₁=Δ^{c}, in the case of tensile loading creep test, where L₁ is the original specimen length, L₂ is the specimen length after the extension, Δ^{c}, creep displacement and ε^{c} is creep strain. However, as OBS is unconventional creep test specimen type, these two relationships, i.e., Equ. 1 and Equ. 2 can't be used to obtain the stress and the strain, because of two issues.
(i) The specimen is loaded using loading pins, therefore the applied load transfers to the specimen bars (the uniform part of the specimen, Lₒ) through the loading pin supporting material in the K region, i.e. dividing the applied load P by the specimen bar cross-section area A (b×d) will not be equal to the nominal stress σₙₒₘ in the specimen bars.
(ii) The creep deformation in the supporting material behind the loading pin (Δₖ^{c}) during the test makes the OBS total deformation (Δ^{c}ₜₒₜₐₗ) higher than the conventional creep specimen deformation (Δ_{L}_{ₒ}^{c}), for the same stress level and same bar length (Lₒ), i.e., Δ^{c}=Δ_{L}_{ₒ}^{c}+Δₖ^{c}. These two issues have been solved, by introducing conversion relationships and conversion factors β and η [1, 2]

### 5.1 Creep Deformation for Unconventional Small Creep Test Specimens

For some components which have simple geometries and simple loading, e.g. beams in bending or thick cylinders subject to internal pressure, it is possible to obtain analytical expressions for the steady-state creep deformation rates, (\dot{Δ}ₛₛ) [2, 6, 7]. For a material obeying a Norton's power law, i.e. \dot{ε}^{c}=Aσⁿ, these can be shown in the general form of:

\dot{Δ}ₛₛ=f₁(n)f₂(dimension)A(σₙₒₘ)ⁿ (3)

where f₁ (n) is a function of the stress index, n, f₂ (dimensions) is a function of the component dimensions and σₙₒₘ is a conveniently determined nominal stress for the component and loading. By introducing an appropriate scaling factor, α, for the nominal stress, Equ. (3) can be rewritten as:

$${\dot{Δ}}_{ss}^{c} = \frac{{f}_{1} ( n )}{{α}^{n}} {f}_{2} ( dimension ) {A ( {ασ}_{nom} )}^{n} \qquad ( 4 )$$

Choosing α (=η) so that f₁(n)/(η)ⁿ is independent (or approximately independent) of n, then Equ. (4) can be further simplified, i.e.

\dot{Δ}ₛₛ^{c}≈D\dot{ε}^{c}(σ_{ref}) (5)

where D is the so-called reference multiplier [D=(f₁(n)/ηⁿ) f₂ (dimensions)] and \dot{ε}^{c}(σ_{ref}) is the minimum creep strain rate obtained from a uniaxial creep test at the so-called reference stress, i.e.

σ_{ref}=ησₙₒₘ (6)

The reference multiplier, D, has unit of length, and can usually be defined by D=βL, where L is a conveniently chosen, “characteristic”, component dimension. Therefore, for the known loading mode and component dimensions, σₙₒₘ can be conveniently defined and if the values of η and β are known, the corresponding equivalent uniaxial stress can be obtained by σ_{ref} (=ησₙₒₘ)′ and the corresponding uniaxial minimum creep strain rate can be obtained using Equ. (5) if \dot{Δ}ₛₛ^{c} is known. These have been published in more detailed in reference [2].

### 5.2 Equivalent Gauge Length (EGL)

For a conventional uniaxial creep test, the creep strain at a given time is usually determined from the deformation of the gauge length (GL). If the gauge length elongation is Δ and the elastic portion is neglected,

$${ɛ}^{c} = \frac{Δ}{GL} \qquad ( 7 a )$$

For non-conventional small specimen creep tests, an equivalent gauge length (EGL) can be defined, if the measured creep deformation can be related to an equivalent uniaxial creep strain, in the same form as that of Equ. (7a), i.e.,

$${ɛ}^{c} = \frac{Δ}{EGL} \qquad ( 7 b )$$

The EGL is related to the dimensions of the specimen and in some cases may be related to the time-dependent deformation of the test specimen. The creep strain and creep deformation given in Equ. (7b) may be presented in a form related to the reference stress, σ_{ref}, i.e.

$${ɛ}^{c} ( {σ}_{ref} ) = \frac{{Δ}^{c}}{D} \qquad ( 8 )$$

in which D (=βL) is the reference multiplier, which is, in fact, the EGL for the test.

From Equ. 8, an expression for the minimum creep strain rate can be obtained, i.e.,

$${\dot{ɛ}}^{c} ( {σ}_{ref} ) = \frac{{\dot{Δ}}^{c}}{D} \qquad ( 9 )$$

In which \dot{ε}^{c} is the minimum creep strain rate at reference stress, \dot{Δ}^{c} is the minimum creep displacement rate and D=βLₒ. Similar to the TBS [1], the overall OBS dimensions do not change significantly during the creep test, therefore the changes in the conversion factors β and η are negligible, therefore Equ. 9 can be rewritten as:—

$${ɛ}^{c} ( {σ}_{ref} ) = \frac{Δ}{β {L}_{o}} \qquad ( 10 )$$

Equ. 10 can be used to convert the entire OBS creep deformation-time curves to the corresponding uniaxial creep strain-time curves

### 6. SPECIMENS MODELLING

Norton material model i.e. \dot{ε}^{c}=Aσⁿ was used in the FE analyses to obtain the minimum displacement rate (\dot{Δ}^{c}) for the OBS, Norton's model was also used to determine the reference stress parameters β and η for the OBS. To obtain rupture time and full deformation time creep curve for the OBS, a continuum damage material behaviour model of Liu and Murakami [8] has been used in the FE analysis. The FE analyses were carried out using the ABAQUS software package [9]. Three dimensional finite element analyses (3D-FE) analyses were carried out for the OBS using meshes which consist of 20-noded brick elements. Because of the symmetry, it was only necessary to model one quarter of the specimens and half of the specimen's thickness, d, as shown in FIG. 5. The boundary conditions, i.e. uₓ=0 on plane A, u_{y}=0 on plane B and u_{z}=0 on plane C, are also indicated in FIG. 5. The specimens is loaded and constrained through four loading pins which are assumed to be “rigid” in the FE model as in FIG. 4 and FIG. 5

### 7. DETERMINATION OF THE REFERENCE STRESS PARAMETERS FOR THE OBS

If an analytical solution for the (\dot{Δ}ₛₛ^{c}), can be obtained, substituting two values of stress index n in the expression f₁(n)/ηⁿ and equating the two resulting expressions allow the value of η to be determined. Hence, σ_{ref} (=ησₙₒₘ) and D can be obtained. This approach was proposed by MacKenzie [10]. However, analytical solutions only exist for a small number of, relatively simple components and loadings [2]. FE analyses was used to determine the reference stress parameters, i.e. the conversion factors η and β, for the OBS. Accurate determination of the reference stress parameters allows the equivalent gauge length (EGL) and the corresponding uniaxial stress for the specimen to be accurately obtained. Using a Norton material model, i.e. \dot{ε}^{c}=Aσⁿ, FE analyses were performed to obtain the steady-state deformation rates between the two loading pins for a range of n values. Similar to FIG. 6. the steady state deformation rates between the loading pins, \dot{Δ}ₛₛ^{x} are normalised, by

$${L}_{o} {A ( α \frac{P}{bd} )}^{n} ,$$

where P is the applied load. However, because only quarter of the specimen is used in the FE analyses and half of the specimen thickness, (see FIG. 5), the obtained minimum deformation rates have to be doubled and the nominal stress will be

$$\frac{P}{0.25 bd} .$$

Several α values were considered for all of the deformation rate values, with different n-values. The value of α which makes

$$log ( \frac{2 {\dot{Δ}}_{ss}^{c}}{{L}_{o} {A ( α \frac{P}{0.25 bd} )}^{n}} )$$

practically independent of n is the required α value. This value (corresponding to the solid, horizontal line in FIG. 6), is the reference stress parameter, η, for the particular OBS geometry and dimensions. The value of β can then be obtained from the intercept of the same solid line in FIG. 6, with the horizontal line, i.e.,

$$log ( \frac{2 {\dot{Δ}}_{ss}^{c}}{{L}_{o} {A ( α \frac{P}{0.25 bd} )}^{n}} ) .$$

The procedure is described in more detail in reference [2]. Using the same procedure the conversion factors, i.e., η and β were fund to be 0.99 and 1.2 respectively for the OBS with the dimensions of, 13.0, 4.0, 2.0, 2.0, 7.0 and 5.0 mm, for Lₒ, k, b, d, H and Dᵢ, respectively.

### 8. THE OBS TEST PROCEDURE

The OBS testing method is based on the principle of converting the specimen load line deformation to the corresponding uniaxial strain using conversion relationships defined by Equ. 9 and Equ. 10; also converting the load applied to the specimen to the corresponding uniaxial stress using Equ. 6. The conversion relationships are only function of specimen dimensions and deformations. The OBS is loaded using four loading pins, two of them are used to constrain the specimen and the other two are used to apply tensile loading to the specimen as shown in FIG. 4. The loading pins are attached to the loading machine using flexible joint, in order to allow good alignment to be achieved during the loading application. The loading fixtures generally have a much higher stiffness, compared to the specimen, and are generally manufactured from a material which has a much higher creep resistance than the tested material, in the current testing program the loading fixture was manufactured using Nimonic Supplier Alloy 80A and the specimens manufactured using P91 and P92 steels. The OBS testing methods can be summarised in the following points:—
1. Small material samples are removed from the component surface or from small materials regions, such as the heat affected zones (HAZ) or weld metal (WM) of welded joints, these small material samples are used to manufacture the OBSs.
2. Determine the conversion factors β and η, using finite element analyses method (FE) for the particular OBS dimensions.
3. Using the OBS dimensions, i.e. (d×b) and η value, the applied load (P) can be obtained, using Equ. 6, for the require stress
4. The OBS is loaded using constant tensile loading and constrained using, four loading pins.
5. The specimen is creep tested at a temperature normally same as the temperature for the tested component and stress levels normally much higher than the operating stress; the high stress allow the specimen fail in shorter times.
6. The deformation of the OBS is recorded throughout the test until the failure of the specimens.
7. The OBS deformation is converted to the corresponding uniaxial strain and strain rate using β value for the specimen and the conversion relationship, i.e., Equ. 9 and Equ. 10.
8. These data than can be used to determine the creep strength for the components or the remaining life time, also it can be used to determine the creep constants for any of creep damage models.

### 9. PRELIMINARY VALIDATION

Preliminary validation of the OBS testing technique was carried out using 3D-FE analyses and Norton's law, to assess the accuracy of the conversion relationships, i.e., Equ. (6) and Equ. (9) and conversion factors, i.e., η and β. The OBS steady state deformation rates were obtained numerically using FE analyses for several n values, using Norton's model and FE analyses. The specimen steady state deformation rates were converted to the minimum strain rate using Equ. (9). The OBS dimensions, Lₒ, k, b, d, H and Dᵢ, were 13.0, 4.0, 2.0, 2.0, 7.0 and 5.0 mm, respectively. These specimen dimensions result in conversion factors β and η values of 1.2 and 0.99 respectively. For this study the magnitude of the material constant A in Norton's law was 1.029E-20 for all cases, and the applied load was corresponded to a constant stress of 50 MPa. The load was calculated using Equ. 6 and the η value for the specimen which is 0.99. Using the same material properties, i.e. (A, n) and stress level, the minimum strain rates (MSRs), have been obtained theoretically using Norton's model for several n values. The theoretical and numerical minimum strain rates are plotted together in FIG. 7, remarkably good correlation is found between the two sets of results.

To obtain a full deformation-time creep curves from the OBS, a continuum damage material behaviour model of Liu and Murakami has been used in the FE analysis [8]. The constitutive damage equations proposed by Liu-Murakami, i.e. Equ. (11) and Equ. (12), introduce a damage parameter, ω, to represent the creep damage in the material. This model consists of a pair of coupled creep/damage equations, i.e.

$$\begin{matrix}\frac{d {ɛ}_{n}^{c}}{d t} = \frac{3}{2} A {σ}_{eq}^{n - 1} {S}_{ij} Exp [ \frac{2 ( n + 1 )}{π \sqrt{1 + 3 / n}} {( \frac{{σ}_{1}}{{σ}_{eq}} )}^{2} {ω}^{3 / 2} ] & ( 11 ) \\ \frac{d ω}{d t} = \frac{M [ 1 - Exp ( - {q}_{2} ) ]}{{q}_{2}} {( {σ}_{r} )}^{X} Exp ( {q}_{2} ω ) & ( 12 )\end{matrix}$$

the rupture stress σᵣ, can be represented by Equ. (13).

σᵣ=ασ₁+(1−α)σ_{eq} (13)

Integration of Equ. (12), under uniaxial conditions, leads to:—

$$ω = - \frac{1}{{q}_{2}} Ln [ 1 - ( 1 - {e}^{- {q}_{2}} ) \frac{t}{{t}_{f}} ] \qquad ( 14 )$$

Also creep strain increments, for the uniaxial case, can be calculated using the following relationship:—

$$\begin{matrix}{Δɛ}^{c} = A {σ}^{n} Exp [ \frac{2 ( n + 1 )}{π \sqrt{1 + 3 / n}} {ω}^{3 / 2} ] Δ t \\ where & ( 15 ) \\ {t}_{f} = \frac{1}{M {σ}^{X}} & ( 16 )\end{matrix}$$

where ω is the damage parameter (0<ω<1), where ω=0 (no damage) and ω=1 (failure), the material constants A, n, M, χ and q₂ it can be obtained by curve fitting to the uniaxial creep curves [2]. Two high temperature materials have been used in the validation, P91 and P92 steels, these materials are used extensively in the power plant pipework. For P91 five uniaxial creep tests have been performed at constant temperature of 650° C., under five stress levels, 70, 83, 87, 93 and 100 MPa. For P92 steel four uniaxial creep tests at constant temperature of 650° C. have been performed, under four different stress levels 110, 120, 130 and 140 MPa. The strain-time curves obtained from these uniaxial creep tests are compared with the corresponding OBS strain-time curves obtained from the FE analyses as in FIG. 8 and FIG. 9. The OBS creep deformation-time curves are converted to the strain-time curves using the relationship given by Equ. 10 and the applied load is calculated using Equ. 6. The conversion factors η and β for the tested OBS were 0.99 and 1.2 respectively. The tested OBS dimensions, Lₒ, k, b, d, H and Dᵢ, were 13.0, 4.0, 2.0, 2.0, 7.0 and 5.0 mm, respectively.

### 10. DISCUSSION

One of the main advantages of the OBS over other small specimen creep testing techniques is that, the small OBS can be used to obtain full creep strain-time curves from the heat-affected zone (HAZ) or from the weld metal (WM) regions of welded joints. The HAZ region is very narrow region between the parent material (PM) and the weld metal (WM), and there are no straight line boundary between the weld metal (WM) and (HAZ) also between the PM and the HAZ. Therefore, distinguishing the HAZ region from the WM and from the PM it could be challenging. Since the OBS has very flexible design, the bar thickness (d) and depth (b) can be increased or decreased as required, in order to capture only the HAZ region. For the OBS, the bar depth and thickness can be changed without increasing the risk of having significant deformation in the loading pins supporting material (k), which will allow accurate determination to the material creep properties. The OBS is unlike the Two bar specimen (TBS) [1] where the loading pin supporting material (the material behind the loading pins) has to be large to avoid significant deformation. In the OBS case the loading area, i.e. the contact areas between the loading pins and the specimen are relatively large in comparison with the bar cross section area, (b×d). This allow the OBS to be machined from even smaller marital samples, the specimens can be manufacture from then slides of materials removed from the HAZ region or from the WM region; or from small scoop samples removed from the component surfaces. The OBS results presented in FIG. 7, FIG. 8 and FIG. 9, indicates that the OBS is capable of obtaining accurate creep strain-time curves when compared with uniaxial creep test results. The OBS conversion relationships are material independent, therefore the high temperature components remaining life can be determined without any knowledge of it is original creep properties of the component material. The OBS has simple geometry and it can be manufactured, loaded and tested easily. In addition, The OBS has the advantage of self-alignment during the loading application which increases the chance of obtain accurate creep data.

### 11. FUTURE WORK

Experimental validation of the OBS testing technique, will be the next step for this research, the tests will be carried out using some of the common power plants high temperature materials, such as, P91 or P92 steels. The OBS creep test results will be compared with the corresponding uniaxial creep test results. In the future the entire specimen will be manufactured from the HAZ region and WM region and then creep tested. Different materials, stress and temperature levels will be used for the validation of the OBS testing techniques. Statistical analyses will be carried out in order to determine the accuracy of the testing technique.

### NOTATION

ε^{c}, \dot{ε}^{c}, \dot{ε}^{c}(σ_{ref}) creep strain, minimum creep strain rate and minimum creep strain rate at reference stress, respectively
Δ^{c}, \dot{Δ}ₛₛ^{c} creep displacement, and steady state displacement rate
β, η, α reference parameters (conversion factors)
σ, σ_{ref}, σₙₒₘ stress, reference stress and nominal stress, respectively
σᵣ, σ₁, σ_{eq} Rupture stress, principle stress and equivalent stress, respectively
Sᵢⱼ Deviatoric stress tensor in Liu-Murakami creep models
D Reference multiplier
EGL Equivalent gauge length
EDM Electrical discharge machining
GL, d_{GL} gauge length and diameter of the gauge length, respectively
HAZ, WM, PM heat-affected zone, weld metal and parent material respectively
Lₒ, b, d, h, R, k The small one bar specimen dimensions (see FIG. 3)
A, n, M, χ, q₂ Material constants in Liu-Murakami and Norton's models
ω, P Damage parameter and the applied load respectively
OBS One Bar Specimen
3D three dimensional
MSR Minimum strain rate

### DESCRIPTION OF THE FIGURES

FIG. 1 standard uniaxial creep test specimen

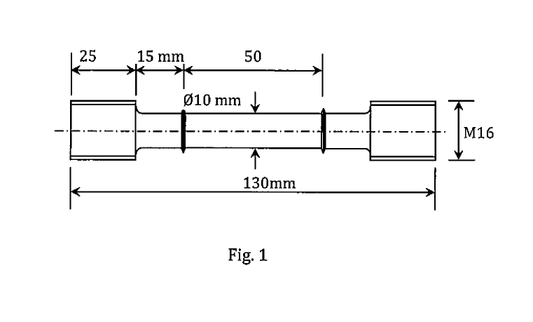

FIG. 2 A typical creep strain time curve, at constant stress and temperature

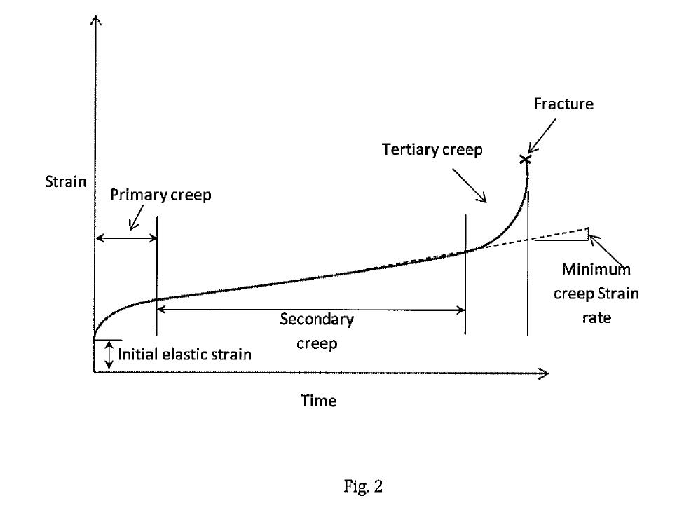

FIG. 3 The small one bar specimen (OBS) shape and dimensions, where Lₒ is the distance between the centres of the loading and concentrating pins ^{˜}6-13 mm, K is the supporting material behind the loading pins ^{˜}2-4 mm, R is the loading pin radius ^{˜}1-2 mm, b is the bar thickness ^{˜}1-2 mm and d is the specimen depth ^{˜}1-2 mm.

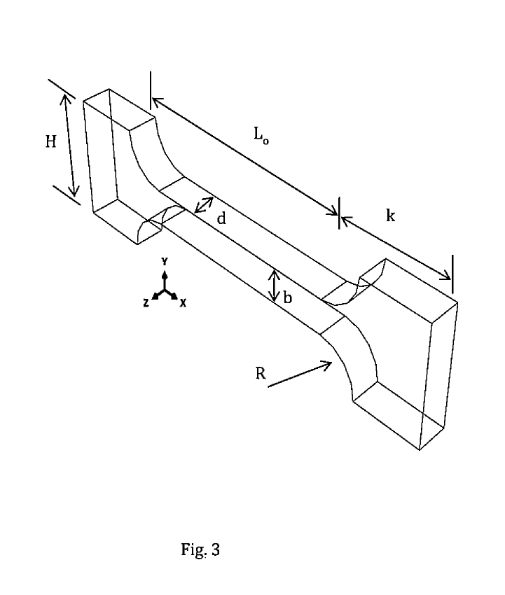

FIG. 4 View of the small one bar specimen OBS with the loading pins and the flexible loading fixture for the loading application

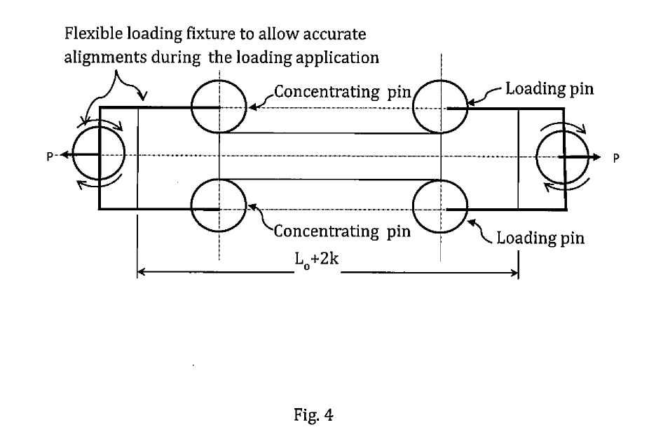

FIG. 5 Finite element mesh and the boundary conditions for the OBS

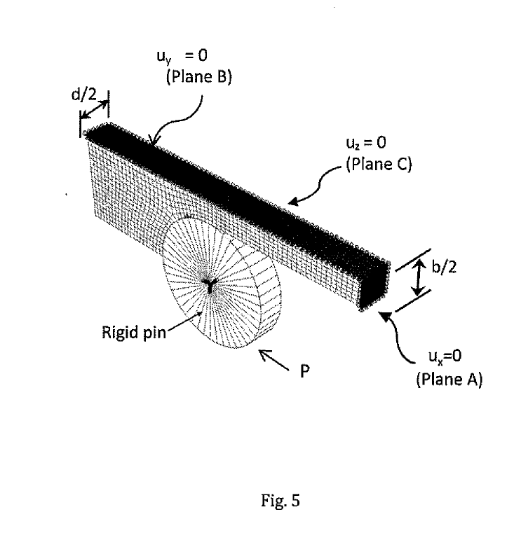

FIG. 6 Determination of β and η parameters for the OBS

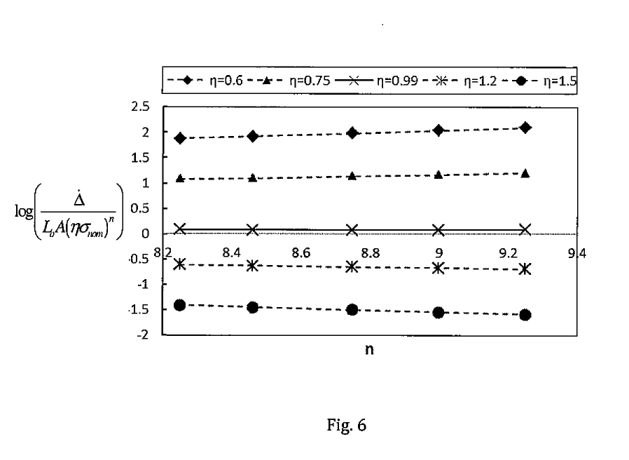

FIG. 7 Comparison between the minimum creep strain rates (MSRs) obtained theoretically and numerically from the OBS

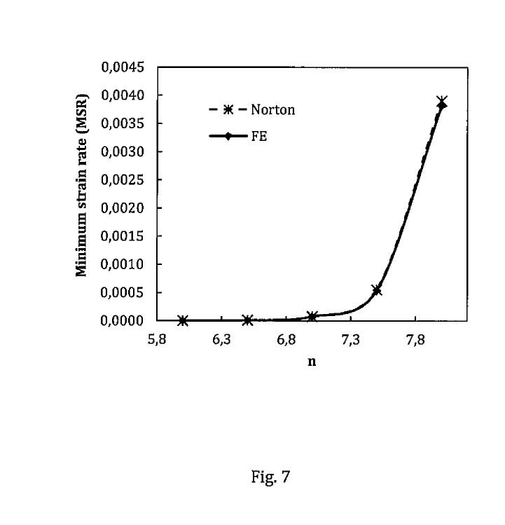

FIG. 8 creep strain-time curves obtained using (i) the FE converted results for the OBS and (ii) experimental uniaxial test results for P91 steel at 650° C., the tests were performed at stresses of 70, 82, 87, 93 and 100 MPa

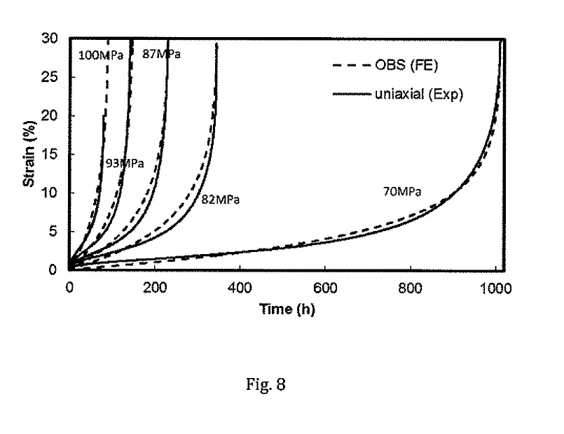

FIG. 9 creep strain-time curves obtained using (i) the FE converted results for the OBS and (ii) experimental uniaxial test results for P92 steel at 650° C., the tests were performed at stresses of 110, 120, 130 and 140 MPa

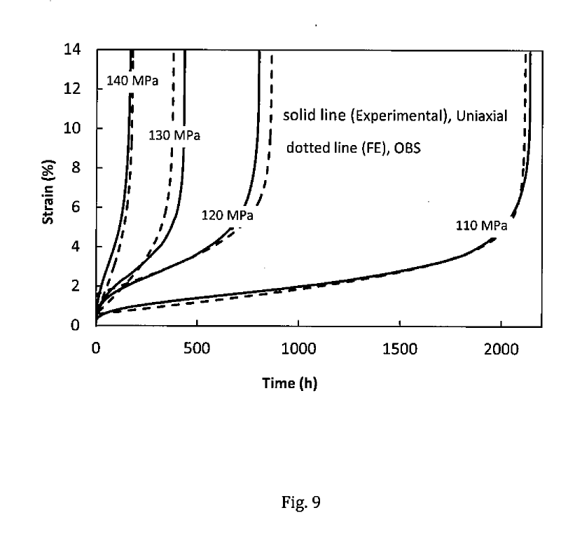

### REFERENCES

1. Balhassn S. M. Ali, Hyde, T. H. and Sun, W., Determination of material creep constants for damage models using a novel small two-bar specimen and the small notched specimen. ASME, Small Modular Reactors Symposium, 15-17 Apr. 2014. V001T02A002; 10 pages, Washington D.C., USA.
2. Balhassn, S. M. Ali, 2014, Development of Non-Destructive Small Specimen Creep Testing Techniques, 225 pages, Thesis submitted to The University of Nottingham, Nottingham, UK.
3. Li, J. C. M., 2002, Impression creep and other localized tests', Materials Science and Engineering: A, vol. 322, no. 1-2, pp. 23-42.
4. Hyde, T. H., Balhassn. S. M., and W. Sun, 2013, Interpretation of Small Ring Creep Tests Data”, The Journal of Strain Analysis for Engineering Design, Vol. 48(4), pp. 269-278.
5. Balhassn S. M. Ali, Determining uniaxial and multiaxial creep data using the small pin loaded one-bar specimen (OBS) and notched bar specimen (SNS4), Energy Technologies Conference (ENTECH'14), 22-24 Dec. 2014, Yildiz Technical University, Istanbul, Turkey.
6. Anderson R. G., Gardener L. R. T. and Hodgkins W. R., 1963, Deformation of uniformly loaded beams obeying complex creep laws, J. Mech. Engng. Sci. 5, pp. 238-244.
7. Johnsson A., 1973, An alternative definition of reference stress for creep, IMechE. Conf. Pub. 13, pp. 205.1-205.7.
8. Liu, Y. & Murakami, S., 1998, Damage localization of conventional creep damage models and proposition of a new model for creep damage analysis, JSME International Journal vol. 41, no. 1, pp. 57-65.
9. ABAQUS, 2010, ABAQUS 6.11-3 Standard user manual, ABAQUS, Inc, USA.
10. MacKenzie, A. C., 1968, On the use of a single uniaxial test to estimate deformation rates in some structures undergoing creep, Int. J. Mech. Sci., Vol. 10, pp 441-453.

1. The pin loaded small one-bar specimen (OBS) designed to obtain the uniaxial minimum strain rate and rupture creep data and to determine the remaining life time for the high temperature components, such as, components in traditional and the nuclear power plants, chemical plants and oil refineries; using small material samples removed from the these components without effecting the component safe operation.

2. The OBS deformation is recorded during the test and then converted to the corresponding uniaxial data using conversion relationships and the conversion factors (β and η), which are specimen dimension dependent and it can be obtained using the finite element analyses.

3. The OBS is loaded through four loading pins, the loading pins and the constraint pins are identical, two pins are used to apply tensile load to the specimen and the other two are used to constrain the specimen under elevated temperature until the rupture of the specimen.

4-15. (canceled)
